(19) United States
(12) Patent Application Publication
(10) Pub. No.: US 2025/0374924 A1
(43) Pub. Date: Dec. 11, 2025

(54) ACTIVE MOLECULES IN THE SECRETOME OF PSEUDOMONAS PROTEGENS PBL3

(71) Applicant: Board of Regents of the University of Nebraska, Lincoln, NE (US)

(72) Inventors: Clemencia Rojas, Lincoln, NE (US); Shilu Dahal, Lincoln, NE (US)

(21) Appl. No.: 19/232,589

(22) Filed: Jun. 9, 2025

Related U.S. Application Data
(60) Provisional application No. 63/657,631, filed on Jun. 7, 2024.

(51) Int. Cl. A01N 43/36; A01N 35/04; A01N 43/78; A01N 63/50; A01P 1/00

(52) U.S. Cl. CPC A01N 43/36; A01N 35/04; A01N 43/78; A01N 63/50; A01P 1/00

(57) ABSTRACT

The present invention provides antimicrobial compositions that comprise pyoverdine, 2,4-diacetylphloroglucinol (2,4-DAPG), pyochelin, pyoluteorin, or a combination thereof. Also provided are methods of using the antimicrobial compositions to inhibit the growth of a microorganism, including methods in which the compositions are used to control bacterial panicle blight of rice, which is caused by the bacterium Burkholderia glumae.

### CROSS-REFERENCE TO RELATED APPLICATIONS

This patent application claims priority to U.S. Provisional Application No. 63/657,631, filed on Jun. 7, 2024, the contents of which are incorporated by reference in their entireties.

### STATEMENT REGARDING FEDERALLY SPONSORED RESEARCH

NR

### BACKGROUND

Rice is a staple food for more than three billion people worldwide. As a result of this demand, rice production has been steadily increasing in the rice-growing areas of the world (Childs & LeBeau, 2023). This global rice production has been severely affected by the bacterium Burkholderia glumae, which causes bacterial seedling rot (BSR) at the early stages of seed germination, and bacterial panicle blight (BPB) at flowering time. BPB directly affects grain quality and grain yield (Ortega & Rojas, 2021, Fory et al., 2014). BPB disease outbreaks have occurred both in tropical regions with prevalent high temperatures and in temperate regions in years in which temperatures were unusually high, especially at night, and more devastating effects have been forecasted due to the constant increase in global temperatures (Echeverri-Rico et al., 2021, Ham et al., 2011, Shew et al., 2019, Zhou, 2019). Currently, there are not effective methods to control BPB. Completely resistant cultivars are not available and chemical control using the quinolone antibiotic oxolinic acid has been restricted to Asia (Hikichi, 1993, Lee et al., 2015) and has proven to be ineffective with the emergence of B. glumae mutants with resistance to this antibiotic (Maeda et al., 2004). Thus, identifying effective antimicrobials against B. glumae is becoming an urgent need.

### SUMMARY

In a first aspect, the present invention provides antimicrobial compositions comprising pyrrolnitrin, pyochelin, pyoverdine, 2,4-diacetylphloroglucinol (2,4-DAPG), pyoluteorin, or a combination thereof.

In a second aspect, the present invention provides methods of inhibiting the growth of a microorganism. The methods comprise contacting the microorganism with an effective amount of an antimicrobial composition described herein, thereby inhibiting its growth.

### BRIEF DESCRIPTION OF THE DRAWINGS

FIG. 1 demonstrates that the Pseudomonas protegens PBL3 secretome retains antimicrobial activity against B. glumae after heat and pepsin treatment. B. glumae at an optical density at 600 nm (OD₆₀₀) of 0.2 was diluted in KB broth and mixed with P. protegens PBL3 secretome that was either heated (A), evaporated (B), or digested with pepsin (C). B. glumae diluted in water or mixed with the untreated P. protegens PBL3 secretome were used as controls. The growth of B. glumae was evaluated after 18 hours. Bars represent the average growth of B. glumae with error bars indicating standard deviations from four biological replicates in three independent experiments. Statistical significance, indicated by letters above the bars, was determined using one-way analysis of variance with Tukey's significant difference test (P value=0.05).

FIG. 2 demonstrates that commercially available secondary metabolites showed varied levels of antibacterial activity in vitro against B. glumae. B. glumae at an OD₆₀₀ of 0.2 was diluted in KB broth and mixed with water, 5% DMSO, 5% ethanol, the P. protgens PBL3 secretome, and one secondary metabolite (i.e., orfamide A, orfamide B, fengycin, pyrrolnitrin, pyochelin, pyoverdine, 2,4-DAPG, or pyoluteorin) at concentrations of 1000 μg/mL, 100 μg/mL, and 10 μg/mL. The growth of B. glumae was evaluated after 18 hours. Bars represent the average growth of B. glumae with error bars indicating standard deviations from three biological replicates in three independent experiments. Statistical significance, indicated by letters above the bars, was determined using a one-way analysis of variance with Tukey's significant difference test (P value <0.05).

FIG. 3 demonstrates that the secondary metabolites 2,4-DAPG, pyoluteorin, and pyochelin were detected in the P. protegens PBL3 secretome using RPLC-MS/MS. A total ion chromatogram (TIC) of P. protegens PBL3 secretome is provided in negative ion mode (A.1.) and positive ion mode (B.1.). An extracted ion chromatogram (EIC) was generated for pyoluteorin (269.97 m/z) and 2,4-DAPG (209.04 m/z) from the P. protegens PBL3 secretome (A.2. and A.4.), and from the corresponding standards (A.3, and A.5.). Similarly, the EIC for pyochelin (325.06 m/z) was generated from the P. protegens PBL3 secretome (B.2.) and from the corresponding standard (B.3.).

FIG. 4 demonstrates that commercially available 2,4-DAPG and pyoluteorin reduced bacterial panicle blight (BPB) symptoms and B. glumae growth in rice panicles. Individual rice panicles were either treated with 1 mL of water or 1 mL of one of the commercially available secondary metabolites (pyochelin, pyoverdine, 2,4-DAPG, or pyoluteorin) at a final concentration of 500 μg/mL; or a 1 mL combination of 2,4-DAPG and pyoluteorin at a final concentration of 250 μg/mL each before spray inoculation with rifampicin-resistant strain of B. glumae inoculum at an OD₆₀₀ of 0.15 (1×10⁷ CFU/mL). Water instead of B. glumae inoculation served as a negative control. Disease symptoms (A) and bacterial populations (B) were evaluated at 3 days post-inoculation (dpi). The bacterial population was also noted just after spraying with B. glumae inoculum as 0 dpi of B. glumae (B). Bars in panel B represent the average growth of B. glumae with error bars representing standard deviations from three biological replicates. Statistical significance, indicated by letters above the bars, was determined using a one-way analysis of variance with Tukey's significant difference test (P value <0.05).

FIG. 5 demonstrates that the Pseudomonas protegens PBL3 secretome enhances germination and growth of B. glumae infected rice seeds. Nipponbare seeds were incubated with B. glumae at an OD₆₀₀ of 0.001, combined with 1% carboxymethylcellulose (CMC) for two hours, and subsequently immersed in P. protegens PBL3 secretome mixed with 1% CMC or water mixed with 1% CMC for two hours. Seeds treated only with water mixed with 1% CMC served as negative controls. Treated seeds were grown on Murashige and Skoog media for 7 days to visualize B. glumae symptoms in seed germination (A), and to quantify shoot (B) and root (C) lengths. The bars in panels B and C represent the average shoot and root length, respectively. Each error bar indicates the standard deviation from 20 replicates. Statistical significance, indicated by letters above the bars, was determined using a one-way analysis of variance with Tukey's significant difference test (P value <0.05).

FIG. 6 demonstrates that the Pseudomonas protegens PBL3 secretome retains antimicrobial activity against B. glumae growth in M9 minimal media. P. protegens PBL3 secretome obtained from bacterial cells grown in M9 minimal media was used to amend KB broth used for B. glumae growth. Non-amended KB with water and amended KB with the secretome were mixed with B. glumae at an OD₆₀₀ of 0.2. The growth of B. glumae was evaluated after 18 hours. Bars represent the average growth of B. glumae measured by OD₆₀₀ with error bars indicating standard deviations from three biological replicates in three independent experiments. Statistical significance indicated by letters above the bars was determined using a student's t-test (P value <0.05).

FIG. 7 demonstrates that commercially available 2,4-DAPG and pyoluteorin do not have additive effects against B. glumae. B. glumae at an OD₆₀₀ of 0.2 was diluted in KB broth and mixed with water, 5% ethanol, 5% DMSO, and one of the following: P. protegens PBL3 secretome, 2,4-DAPG₁₀₀ (100 μg/mL), 2,4-DAPG₁₀ (10 μg/mL), pyoluteorin₁₀ (10 μg/mL), a combination of 2,4-DAPG₁₀ and pyoluteorin₁₀ at 10 μg/mL each, or a combination of 2,4-DAPG₁₀₀ (100 μg/mL) and Pyoluteorin₁₀ (10 μg/mL). The growth of B. glumae was evaluated after 18 hours. Bars represent the average growth of B. glumae with error bars indicating standard deviations from three biological replicates in three independent experiments. Statistical significance, indicated by letters above the bars, was determined using a one-way analysis of variance with Tukey's significant difference test (P value <0.05).

### DETAILED DESCRIPTION

The present invention provides antimicrobial compositions that comprise pyoverdine, 2,4-diacetylphloroglucinol (2,4-DAPG), pyochelin, pyoluteorin, or a combination thereof. Also provided are methods of using the antimicrobial compositions to inhibit the growth of a microorganism, including methods in which the compositions are used to control bacterial panicle blight of rice, which is caused by the bacterium Burkholderia glumae.

In previous work, the present inventors identified a bacterial isolate, Pseudomonas protegens PBL3 (deposited as ARS Culture Collection Accession No. B-68083), that has antagonistic activity against B. glumae both in vitro and in planta. They determined that the antimicrobial activity of this bacterium is present within its secretome, and they identified secondary metabolite biosynthetic gene clusters within the genome of this bacterium that might be responsible for the antimicrobial activity. This previous work is described in U.S. Pat. No. 11,999,963 and in Ortega et al. (Phytopathology 110 (10): 1657-1667, 2020), which are each incorporated by reference in their entireties.

As is described in the Examples of the present application, the inventors have now identified specific secondary metabolites that contribute to the antimicrobial activity of P. protegens PBL3. Specifically, they determined that the metabolites pyrrolnitrin, pyochelin, pyoverdine, 2,4-DAPG, and pyoluteorin, which are all predicted to be encoded by the PBL3 genome, have anti-B. glumae activity in vitro. However, of these metabolites, they were only able to detect pyochelin, 2,4-DAPG, and pyoluteorin in the PBL3 secretome. Additionally, they demonstrated that two of these metabolites, 2,4-DAPG and pyoluteorin, significantly reduce the growth of B. glumae and the symptoms of bacterial panicle blight in planta.

### Antimicrobial Compositions:

In a first aspect, the present invention provides antimicrobial compositions comprising pyrrolnitrin, pyochelin, pyoverdine, 2,4-diacetylphloroglucinol (2,4-DAPG), pyolutcorin, or a combination thereof.

As used herein, the term “antimicrobial” is used to describe a composition that kills or inhibits the growth or reproduction of a microorganism. Suitable microorganisms that can be inhibited using the compositions of the present invention are described in the section titled “Methods” below.

Pyrrolnitrin, pyochelin, pyoverdine, 2,4-diacetylphloroglucinol (2,4-DAPG), and pyoluteorin are secondary metabolites that are predicted to be encoded by gene clusters found within the genome of P. protegens PBL3. The inventors have demonstrated that all these metabolites have activity against B. glumae in vitro and that at least three of them (i.e., pyochelin, 2,4-DAPG, and pyoluteorin) are present in the PBL3 secretome. Thus, they have determined that three or more of these metabolites contribute to the anti-B. glumae activity of P. protegens PBL3. Accordingly, the compositions may comprise one or more metabolites selected from pyrrolnitrin, pyochelin, pyoverdine, 2,4-DAPG, and pyoluteorin. Specifically, the compositions may comprise one, two, three, four, or all five of these metabolites.

In the Examples, the inventors demonstrate that pyrrolnitrin, pyochelin, pyoverdine, 2,4-DAPG, and pyoluteorin inhibit the growth of Burkholderia glumae over a range of different concentrations. Specifically, they show that pyrrolnitrin inhibits B. glumae at a concentration of 1000 μg/mL; pyochelin inhibits B. glumae at a concentration of 1000 μg/mL; pyoverdine inhibits B. glumae at a concentration of 10 μg/mL, 100 μg/mL, or 1000 μg/mL; 2,4-DAPG inhibits B. glumae at a concentration of 10 μg/mL, 100 μg/mL, or 1000 μg/mL; and pyoluteorin inhibits B. glumae at a concentration of 10 μg/mL, 100 μg/mL, or 1000 μg/mL. Thus, in some embodiments, the compositions comprise (a) pyrrolnitrin at a concentration of 100-5000 μg/mL; (b) pyochelin at a concentration of 50-5000 μg/mL, 250-3000 μg/mL, 500-2000 μg/mL, or 750-1000 μg/mL; (c) pyoverdine at a concentration of 5-5000 μg/mL, 10-3000 μg/mL, 50-2000 μg/mL, or 100-1000 μg/mL; (d) 2,4-DAPG at a concentration of 5-5000 μg/mL, 10-3000 μg/mL, 50-2000 μg/mL, or 100-1000 μg/mL; (e) pyoluteorin at a concentration of 5-5000 μg/mL, 10-3000 μg/mL, 50-2000 μg/mL, or 100-1000 μg/mL, or (f) any combination thereof. In certain embodiments, the compositions comprise (a) pyrrolnitrin at a concentration of 1000 μg/mL; (b) pyochelin at a concentration of 100 μg/mL or 1000 μg/mL; (c) pyoverdine at a concentration of 10 μg/mL, 100 μg/mL, or 1000 μg/mL; (d) 2,4-DAPG at a concentration of 10 μg/mL, 100 μg/mL, or 1000 μg/mL; (c) pyoluteorin at a concentration of 10 μg/mL, 100 μg/mL, or 1000 μg/mL; or (c) any combination thereof.

The inventors have demonstrated that several of the compositions described herein can be used to inhibit the growth of B. glumae on rice plants and thereby reduce the symptoms of bacterial panicle blight (BPB). Thus, in some embodiments, the compositions are agricultural compositions. An “agricultural composition” is a composition formulated for application to a plant or plant part. Agricultural compositions are commonly formulated as a liquid (i.e., liquid suspension) for application by spraying or soaking, but may also be formulated in a solid, granular, or powder form for rehydration or application by dusting or dry coating. The agricultural composition may be concentrated (e.g., by lyophilization) for dilution in water or another solvent. The agricultural compositions may be prepared for administration to plants or may be prepared for administration to seeds. The agricultural compositions may include at least one secondary metabolite described herein (i.e., pyoverdine, 2,4-DAPG, pyochelin, and/or pyoluteorin) and a carrier. As used herein, a “carrier” may be solid or liquid and may include substances ordinarily employed in formulations applied to plants. Suitable carriers include buffers, water, oils, nonionic surfactants, ionic surfactants, or agricultural by-products. In some embodiments, the agricultural compositions also include an additional active ingredient, such as a fungicide, an herbicide, an insecticide, a biosanitizer product, or a fertilizer.

### Methods:

In a second aspect, the present invention provides methods of inhibiting the growth of a microorganism. The methods comprise contacting the microorganism with an effective amount of an antimicrobial composition described herein, thereby inhibiting its growth.

A “microorganism” is a microscopic organism. The growth of any microorganism may be inhibited by the methods of the present invention. Suitably, the microorganism is a bacterium or fungus. In the Examples, the secondary metabolites pyoverdine, 2,4-DAPG, pyochelin, and pyoluteorin were only tested against the rice pathogen Burkholderia glumae. However, in previous work, the inventors have shown that the bacterial strain from which these products were identified, P. protegens PBL3, inhibits the growth of several additional plant pathogens, including bacterial pathogens from the genera Burkholderia, Xanthomonas, and Erwinia, as well as fungal pathogens from the genera Rhizoctonia, Pythium, Magnaporthe, and Fusarium. See U.S. Pat. No. 11,889,834 (note: PBL3 is referred to as Pseudomonas fluorescens PBL13 in this application but was later reclassified based on 16S rRNA sequencing), which is hereby incorporated by reference in its entirety. Thus, in some embodiments, the microorganism is a bacterium of the genera Burkholderia, Xanthomonas, or Erwinia, or a fungus of the genera Rhizoctonia, Pythium, Magnaporthe, or Fusarium. In preferred embodiments, the microorganism is Burkholderia glumae.

Inhibition of growth of a microorganism may be assessed using any method known in the art. Suitable methods include, for example, plate inhibition assays. In embodiments in which the microorganism is a plant pathogen, the antimicrobial composition can be applied to the plant (e.g., injected into the plant or applied to the seeds of the plant), and the growth of the microorganism on the plant or the microbial damage to the plant can be measured.

“Effective amount” is intended to mean an amount of an antimicrobial composition described herein that is sufficient to inhibit the growth of a microorganism by, for example, at least 10%, 20%, 50%, 75%, 80%, 90%, 95%, or 1-fold, 3-fold, 5-fold, 10-fold, 20-fold, or more compared to a negative control that does not comprise the antimicrobial composition.

In some embodiments, the methods are used to inhibit the growth of a microorganism that is on a plant. As used herein, a “plant” includes any portion of the plant including, without limitation, a whole plant or a portion of a plant such as a part of a root, leaf, stem, seed, pod, flower, cell, tissue plant germplasm, asexual propagate, or any progeny thereof. For example, the term “rice plant” can refer to a whole rice plant or portions thereof including, without limitation, the leaves, roots, seeds or otherwise. Suitable “plants” may include, without limitation, rice, tomato, onion, cotton, soybean, wheat, ryegrass, crucifers, prunus, beans, kiwi fruit, mango, apple, pear, sunflower, maple, European horse chestnut, Indian horse chestnut, beet, hazelnut, barley, cucumber, cabbage, mulberry, cherry, millet, pea, olive, tobacco, camellia, sorghum, and corn. In certain preferred embodiments, the plant is a rice plant.

The inventors have demonstrated that several of the antimicrobial compositions described herein can be used to inhibit the growth of B. glumae on rice plants and thereby reduce the symptoms of bacterial panicle blight (BPB). Thus, in some embodiments, the plant is a rice plant and the method reduces the symptoms of BPB. BPB causes various symptoms on rice plants, including grain discoloration, sterility, and panicle rotting. Early signs of BPB include light-to-medium brown discoloration in the lower third to half of the grains, with green panicle branches remaining upright. As the disease progresses, panicles may rot, and grain filling may be severely affected, leading to a higher percentage of unfilled or discolored grains. Any symptom of BPB may be reduced by the methods of the present invention.

Several methods of “contacting” may be used to apply an antimicrobial composition to a plant. Suitable application methods include, without limitation, spraying or dusting. Contacting may also be carried out indirectly, for example, via application to the soil surrounding a plant or to plant media or substrates. Alternatively, the antimicrobial composition may be injected into the plant. The contacting step of the present methods may be carried out before or after the microorganism grows on the plant. In other words, the methods may be used as a preventative measure or may be used only on plants or in fields that microbial damage is suspected or noted. In some embodiments, the leaves or seeds of the plant are contacted with the antimicrobial composition. In some embodiments, the contacting is carried out before flowering or during panicle formation.

In some embodiments, the plant is contacted at least 2, 3, 4, 5, or more times with an antimicrobial composition described herein. For example, the seeds of the plant could be treated with the antimicrobial composition prior to planting and then the antimicrobial composition could be sprayed onto the growing plants at one or more stage of development.

The present disclosure is not limited to the specific details of construction, arrangement of components, or method steps set forth herein. The compositions and methods disclosed herein are capable of being made, practiced, used, carried out and/or formed in various ways that will be apparent to one of skill in the art in light of the disclosure that follows. The phraseology and terminology used herein is for the purpose of description only and should not be regarded as limiting to the scope of the claims. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples or exemplary language (e.g., “such as”) provided herein, is intended merely to facilitate the disclosure and does not imply any limitation on the scope of the disclosure unless otherwise claimed. No language in the specification, and no structures shown in the drawings, should be construed as indicating that any non-claimed element is essential to the practice of the disclosed subject matter. The use herein of the terms “including,” “comprising,” or “having,” and variations thereof, is meant to encompass the elements listed thereafter and equivalents thereof, as well as additional elements. Embodiments recited as “including,” “comprising,” or “having” certain elements are also contemplated as “consisting essentially of” and “consisting of” those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like. All percentages referring to amounts are by weight unless indicated otherwise.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference unless explicitly indicated otherwise. The present disclosure shall control in the event there are any disparities between any definitions and/or descriptions found in the cited references.

The following examples are meant only to be illustrative and are not meant as limitations on the scope of the invention or of the appended claims.

### EXAMPLES

Rice production worldwide is threatened by the disease bacterial panicle blight (BPB), which is caused by Burkholderia glumae. Despite the threat, resources to control this disease, such as completely resistant cultivars or effective chemical methods, are still lacking. However, the need to control this disease has paved the way to explore biologically based approaches harnessing the antimicrobial activities of environmental bacteria. Previously, the environmental bacterium Pseudomonas protegens PBL3 was identified as a potential biological control agent with antimicrobial activity against B. glumae. Such antimicrobial activity in vitro and in planta was associated with the P. protegens PBL3 bacteria-free secreted fraction (secretome), although the specific molecules responsible for this activity have remained elusive. In this work, we advance the characterization of the P. protegens PBL3 secretome, by evaluating the antimicrobial activity in vitro of selected secondary metabolites predicted by the P. protegens PBL3 genomic sequence against B. glumae. In addition, use of reversed phase liquid chromatography tandem mass spectrometry (RPLC-MS/MS) of the P. protegens PBL3 secretome enabled us to successfully detect and quantify the secondary metabolites pyoluteorin, 2,4-diacetylphloroglucinol (2,4-DAPG), and pyochelin. Among those, pyoluteorin and 2,4-DAPG reduced the growth of B. glumae in vitro and reduced the symptoms of BPB and bacterial growth in planta, suggesting that these compounds could be effective as biopesticides to mitigate BPB.

### INTRODUCTION

Rice is a staple food for more than three billion people worldwide. As a result of this demand, rice production has been steadily increasing in the different rice-growing areas of the world (Childs and LeBeau 2023). This global rice production has been severely affected by the bacterium Burkholderia glumae, which causes bacterial seedling rot (BSR) at the early stages of seed germination, and bacterial panicle blight (BPB) at flowering time, the latter directly affecting grain quality and grain yield (Fory et al. 2014; Ortega and Rojas 2021). BPB disease outbreaks have occurred in tropical regions with prevalent high temperatures, or in temperate regions in years when temperatures have been unusually high, especially at night, with more devastating effects forecasted due to the constant increase in global temperatures (Echeverri-Rico et al. 2021; Ham et al. 2011; Shew et al. 2019; Zhou 2019). Currently, there are no effective methods to control BPB. Completely resistant cultivars are not available, and chemical control using the quinolone antibiotic oxolinic acid has been restricted to Asia (Hikichi 1993; Lee et al. 2015) and proven ineffective with the emergence of B. glumae mutants with resistance to this antibiotic (Macda et al. 2004). Thus, identifying effective antimicrobials against B. glumae is becoming an urgent need.

A promising approach for managing BPB is through biological control, as several bacterial strains from the genera Actinobacteria, Bacillus, Cytobacillus, Burkholderia, Enterobacter, Pantoea, and Streptomyces with antagonistic activity against B. glumae have been discovered (Atuesta et al. 2020; Betancur et al. 2020; Chung et al. 2015; Kouzai and Akimoto-Tomiyama 2022; Ngalimat et al. 2022; Pedraza-Herrera et al. 2021; Shrestha et al. 2016; Suarez-Moreno et al. 2019). In addition to those strains, we previously identified an isolate of Pseudomonas protegens, P. protegens PBL3, with antagonistic activity against B. glumae in vitro and in planta, and further demonstrated that this antimicrobial activity is associated with molecules that P. protegens PBL3 secretes to the culture media (secretome) (Ortega et al. 2020).

To gain insight into the possible molecules responsible for this antimicrobial activity in P. protegens PBL3, we sequenced its genome and identified several gene clusters associated with the synthesis of secondary metabolites, including orfamides, pyrrolnitrin, pyoluteorin, 2,4-diacetylphloroglucinol (2,4-DAPG), pyoverdine, pyochelin, fengycin, lipopeptide 8D1-1/8D1-2, thiazostatin, watasemycin B, enantiopyochelin, isopyochelin, bacteriocins, cyclodipeptides, N-acetylglutaminylglutamine amide, and arylpolyene pigment (Ortega et al. 2020). Some of those secondary metabolites have been previously identified in other strains of P. protegens and have been recognized for their antimicrobial activities against fungal and bacterial plant pathogens (Balthazar et al. 2022; Castro Tapia et al. 2020; Gu et al. 2022; Howell and Stipanovic 1980; Maurhofer et al. 1994; Michavila et al. 2017; Rai et al. 2017), although their impact on B. glumae remains unknown.

This study aimed to achieve two goals: 1) evaluating the antagonistic effect of the P. protegens PBL3 predicted secondary metabolites against B. glumae by evaluating the commercially available equivalents, and 2) detecting and quantifying in the P. protegens PBL3 secretome the secondary metabolites predicted by the P. protegens PBL3 genomic sequence by reversed phase liquid chromatography tandem mass spectrometry (RPLC-MS/MS). We found that pyrrolnitrin, pyochelin, pyoverdine, 2,4-DAPG, and pyoluteorin significantly reduce the growth of B. glumae in vitro. Out of those secondary metabolites, we were only able to detect pyochelin, 2,4-DAPG, and pyoluteorin in the P. protegens PBL3 secretome, and they were present at concentrations below the minimum inhibitory concentration required for B. glumae inhibition. Nevertheless, application of purified 2,4-DAPG and pyoluteorin to panicles, before inoculation with B. glumae, reduced disease symptoms and bacterial populations in rice panicles. In addition, using the entire P. protegens PBL3 secretome on B. glumae-infected seeds improved seed germination. Altogether, the results from this work revealed that the secondary metabolites predicted by the P. protegens PBL3 genomic sequence only account for part of the antimicrobial activity against B. glumae. More work is needed to unveil the entire repertoire of molecules in the P. protegens PBL3 and dissect those directly responsible for its activity.

### Materials and Methods

### Bacterial Strains

Wild-type B. glumae and a rifampicin-resistant strain were grown on KB media (King et al., 1954). P. protegens PBL3 was grown on Luria Bertani (LB) media (Bertani, 1951).

Preparation of P. protegens PBL3 Secretome

A single colony of P. protegens PBL3 was grown in 1×M9 minimal media (Sigma Aldrich, St. Louis, MO) supplemented with filter-sterilized 56 mM Myo-inositol, 2 mM MgSO₄·7H₂O, and 0.2 mM CaCl₂). The culture was incubated at 25° C. with constant agitation (210 rpm) for 60 hours until reaching an optical density at 600 nm (OD₆₀₀) of 0.5. Bacterial culture was centrifuged at 10,000 rpm for 10 minutes. The bacterial pellet was discarded and the supernatant, containing the secreted fraction (secretome) was transferred to a new tube and filter-sterilized using a 0.22 μm filter (Fisher Scientific, Ireland) to eliminate any residual bacterial suspension.

### Preparation of Commercial Compounds

Orfamide A, orfamide B, pyrrolnitrin, and pyoluteorin (Cayman Chemical Company, Ann Arbor, MI), and pyochelin (Santa Cruz Biotechnology, Dallas, TX), were diluted in 5% dimethyl sulfoxide (DMSO) at 1000 μg/mL and further diluted to 100 μg/mL and 10 μg/mL. Similarly, pyoverdine (Sigma-Aldrich, Saint Louis, MO) was diluted in water, whereas 2,4-DAPG (ThermoFisher Scientific, Poland) and fengycin (Sigma-Aldrich, Saint Louis, MO) were diluted in 5% ethanol at 1000 μg/mL and further diluted to 100 μg/mL and 10 μg/mL.

### Antimicrobial Assays In Vitro

Burkholderia glumae grown on KB was scraped from the agar and resuspended in sterile water to a final OD₆₀₀ of 0.2. One hundred microliters of B. glumae was added to 200 μL of KB broth to make a master mix. The master mix was supplemented with either water, 5% DMSO, or 5% ethanol, used as control. Alternatively, master mix was supplemented with either P. protegens PBL3 secretome or different compounds (orfamide A, orfamide B, fengycin, pyrrolnitrin, pyochelin, pyoverdine, 2,4-DAPG, or pyoluteorin), each at three concentrations of 1000 μg/mL, 100 μg/mL, and 10 μg/mL, or combination of compounds. Two compound combinations were chosen, the first combination consisted of 2,4-DAPG and pyoluteorin at final concentrations of 100 μg/mL and 10 μg/mL, respectively. The second combination consisted of 2,4-DAPG and pyoluteorin, each at concentration of 10 μg/mL. The resulting mixture was incubated in a shaker incubator at room temperature and 210 rpm for 18 hours. The growth of B. glumae was evaluated by measuring the OD₆₀₀ using a spectrophotometer (Genesys 140, Thermoscientific, Madison, WI, USA). Each experiment was replicated three times.

### Antimicrobial Assays in Planta

To evaluate the effect of commercially available pyochelin, pyoverdine, 2,4-DAPG, and pyoluteorin on disease development caused by B. glumae, rice accession Kitaake was grown in a growth chamber under conditions of 30° C. (day), 22° C. (night), 15 hours of light, 9 hours of darkness, and 50% relative humidity. At the 50% heading (R4) stage, three independent panicles were selected for each treatment and each panicle was treated with either 1 mL of water mixed with 0.2% Tween 20; or 1 mL of each of the commercially available compounds (pyochelin, pyoverdine, 2,4-DAPG, or pyoluteorin) mixed with 0.2% Tween 20 at a final concentration of 500 μg/mL; or a combination of 2,4-DAPG and pyoluteorin at final concentration of 250 μg/mL, each mixed with 0.2% Tween 20. At 24 hours after chemical pre-treatment, a rifampicin-resistant strain of B. glumae at OD₆₀₀=0.15 (1×10⁷ CFU/mL), was sprayed onto each one of the pre-treated panicles. Panicles sprayed only with water served as negative controls. To have a base number count for bacterial colonies, panicles pre-treated with water and sprayed with B. glumae were harvested immediately to calculate bacterial population as 0 days post-inoculation (dpi) of B. glumae. The remaining panicles were bagged for 24 hours to create a conducive environment for disease development. Symptom assessment was conducted at 0, 1, 2, and 3 dpi, panicles were harvested, ground, and serially diluted, and plated on KB media containing rifampicin at a concentration of 50 μg/mL, to quantify populations of B. glumae. Plates were incubated at 28° C. and colonies were counted after 2 days.

Antimicrobial Assay on Seeds Infected with B. glumae

We further evaluated the effectiveness of the entire P. protegens PBL3 secretome on the germination and growth of rice seeds infected with B. glumae. Sixty seeds from the BPB-susceptible cultivar, Nipponbare were surface-sterilized by soaking them in 70% ethanol, and 30% bleach solution, followed by rinsing with sterile deionized water (Ortega et al. 2020). Forty seeds were incubated with a 20 mL of an inoculum of B. glumae at OD₆₀₀=0.001 combined with 1% carboxymethylcellulose (CMC) in a shaker incubator at room temperature and 100 rpm for 2 hours. Twenty seeds were used as control and treated with water mixed with 1% CMC for 2 hours. Following the incubation period, seeds pre-treated with B. glumae and those pre-treated with water were both air-dried for 15 minutes. Twenty seeds pre-treated with B. glumae were then immersed in either 10 mL of P. protegens PBL3 secretome mixed with 1% CMC or in 10 mL of water mixed with 1% CMC. Seeds pre-treated with water were again incubated in water mixed with 1% CMC and served as the negative control. P. protegens PBL3 secretome-treated and control seeds were incubated in a shaker incubator at room temperature and 100 rpm for 2 hours. Seeds were air-dried for 15 minutes and transferred to mason jar filled with Murashige and Skoog media, sealed with surgical tape, and incubated at 28° C. in the dark for 2 days and in a growth chamber at 25° C. with a photoperiod of 15 hours of light and 9 hours of darkness for 5 days. Each treatment condition was replicated in four jars, each containing 5 seeds.

Heat and Evaporation Treatment of the P. protegens PBL3 Secretome

The P. protegens PBL3 secretome was placed in a heat bath at 95° C. for 10 minutes. In addition to the heat treatment, an evaporation assay was conducted to determine the stability of the secretome. The P. protegens PBL3 secretome was subjected to vacuum evaporation for 18 hours using a SpeedVac system (Savant SpeedVac DNA130, Long Branch, NJ). This process resulted in the removal of all liquid content (M9 minimal media) from the secretome. Subsequently, the evaporated secretome was reconstituted by resuspending it in the same volume of water. The resuspended secretome was then subjected to an antimicrobial assay to assess the activity of the evaporated fraction. Both the heat treatment and evaporation assays were repeated three times.

Pepsin Digestion of the P. protegens PBL3 Secretome

Pepsin extracted from the porcine stomach (Promega, Madison, WI) was dissolved in distilled water adjusted to pH 2 (following manufacturer's recommendations) to a final concentration of 1 mg/mL. For pepsin digestion, the P. protegens PBL3 secretome was adjusted to pH 3 with 10 μL of 5 M HCl. Pepsin was added to the P. protegens PBL3 secretome at a recommended ratio of 1:20 (pepsin:secretome) and incubated on a thermomixer (850 rpm) at 37° C. for 5 hours. A sample subjected to the same processing but without pepsin was used as a control. To terminate the reaction, the temperature was increased to 95° C. for 10 minutes. The pH of the digested P. protegens PBL3 secretome was adjusted to pH 7 by adding 80 μL of IN NaOH and used for antimicrobial assay. The entire experiment was repeated three times, with four biological replicates of P. protegens PBL3.

### Small Molecule Profiling and Quantification Using Reversed Phase Liquid Chromatography Tandem Mass Spectrometry (RPLC MS/MS)

An aliquot of 500 μL of the P. protegens PBL3 secretome samples was vacuum dried down using a SAVANT speed-vac and resuspended in 50 μL of 50% methanol. Samples were run by reverse phase (RP) on a ACCQ-TAG ULTRA C18 1.7 um (2.1×100 mm, Waters) column using a Vanquish (Thermo) HPLC at 40° C. and at a flow rate of 300 μL/min with a gradient of A (0.1% formic acid in 100% LC-MS grade water) and B (0.1% formic acid in 100% acetonitrile) as follow: 2% B for 2 min, 2% to 50% B in 9 min, 50% to 95% B in 4 min, hold at 95% B for 3.5 min, then back to 2% in 0.5 min. The samples were injected twice to acquire in positive and in negative ion mode. The QE-HF was run in a data-dependent acquisition mode triggering on peaks with charge states 1 to 2 using a mass range of 100 to 1500 m/z at 60,000 resolution, with an AGC target of 5e5 and a maximum ion time of 54 ms. The isolated ions were further fragmented by HCD using isolation window of 1.6 m/z and scanned at a resolution of 15,000. The standards for commercially available compounds orfamide A, orfamide B, fengycin, pyrrolnitrin, pyochelin, pyoverdinc, 2,4-DAPG, and pyoluteorin, at the concentration of 1000 μg/mL and their dilution series were prepared and run alongside the samples of P. protegens PBL3 secretome. The limits of quantification for each compound using 1 μL injection were as follows; orfamide A at 3.13 μM, orfamide B at 6.25 μM, pyrrolnitrin at 15.63 μM, pyoluteorin at 0.78 μM, pyochelin at 0.31 μM, and 3.13 μM for 2,4-DAPG.

### Results

The Antimicrobial Activity of the P. protegens PBL3 Secretome is not Associated with Large Molecular Weight Proteins

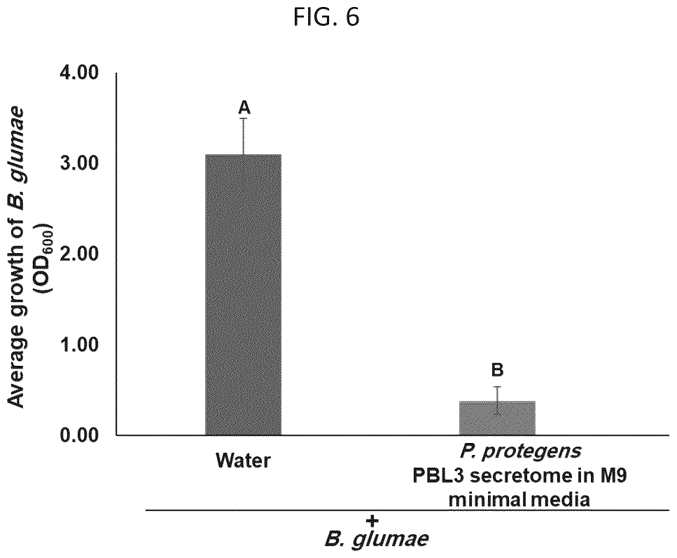

We previously found that the antimicrobial activity of the P. protegens PBL3 secretome was associated with molecules of different molecular mass (Ortega et al. 2020). To facilitate the bioanalytical characterization of the P. protegens PBL3 secretome, we grew P. protegens PBL3 in 1×M9 minimal media to reduce the chemical complexity of the secretome. The results showed that the secretome isolated from P. protegens PBL3 culture in 1×M9 minimal media still retains antimicrobial activity against B. glumae, as revealed by a considerable decrease in the growth of B. glumae from an OD₆₀₀ of 3.10 (when B. glumae was grown alone) to 0.38 (when grown with P. protegens PBL3 secretome) (FIG. 6).

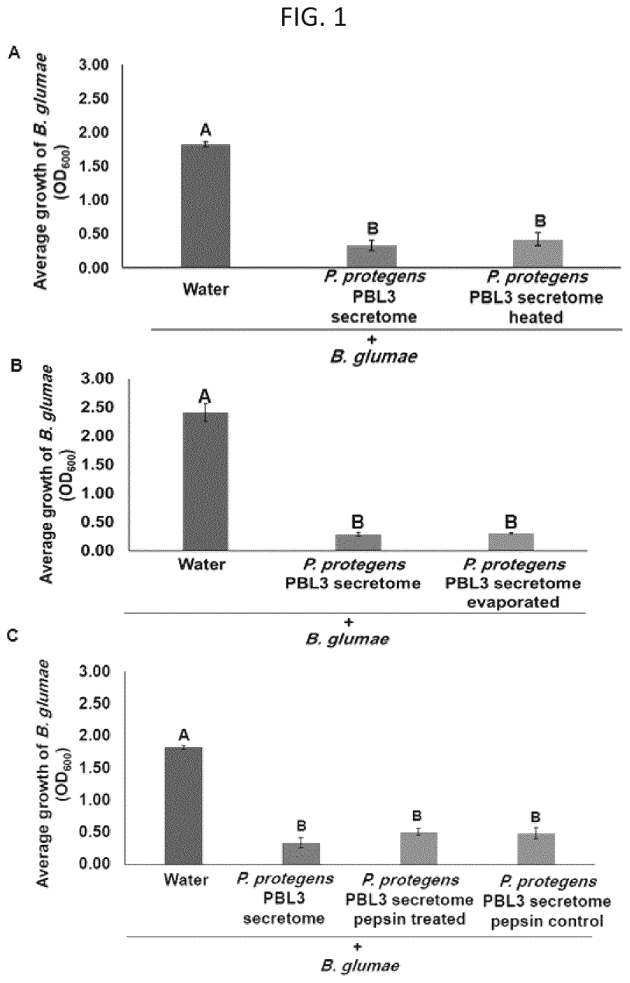

To start narrowing down chemical categories and completely rule out the antimicrobial effect of large proteins, we subjected the P. protegens PBL3 secretome to heat treatment and used this heat-treated secretome to amend the KB broth used for B. glumae growth. The results showed that B. glumae in non-amended KB grew to an OD₆₀₀ of 1.85, whereas the growth of B. glumae in KB amended with P. protegens PBL3 secretome showed an 85% reduction, reaching an OD₆₀₀ of 0.3. The growth of B. glumae in KB amended with heated P. protegens PBL3 secretome showed an 82% reduction, reaching an OD₆₀₀ of 0.34, which is equivalent to the non-heat-treated control (FIG. 1A). In addition, when the P. protegens PBL3 secretome was evaporated, resuspended in water, and used to amend the KB for B. glumae growth, it effectively reduced the growth of B. glumae in comparison to levels equivalent to the non-evaporated control P. protegens PBL3 secretome (FIG. 1B).

To further rule out the proteinaccous nature of the antimicrobial activity of the P. protegens PBL3 secretome, we used an enzymatic essay. We previously found that treatment with proteinase K, a serine protease, did not eliminate the antimicrobial activity of the P. protegens PBL3 secretome (Ortega et al. 2020). Similar results were obtained with pepsin, an aspartic protease when the P. protegens PBL3 secretome was treated with pepsin and further used to amend the KB broth used for B. glumae growth, using a control P. protegens PBL3 secretome without pepsin treatment for comparison. The results showed that B. glumae in KB grew to an OD₆₀₀ of 1.85, whereas it was significantly reduced when amended with the P. protegens PBL3 secretome, as shown previously. The growth of B. glumae in KB amended with the pepsin-treated P. protegens PBL3 secretome was reduced by 75%, but that reduction mirrored the inhibitory effect exhibited by the undigested P. protegens PBL3 secretome and control experiment without pepsin (FIG. 1C). These findings conclusively establish that large proteins do not contribute to the antimicrobial properties of the P. protegens PBL3 secretome. Secondary metabolites predicted in the genomic sequence of P. protegens PBL3 have various levels of antimicrobial activity against B. glumae

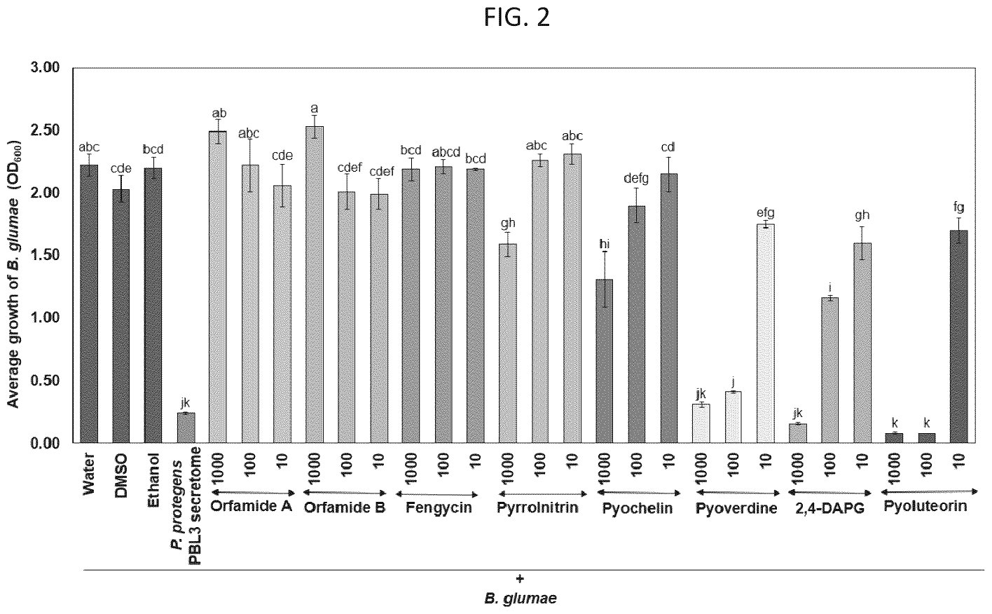

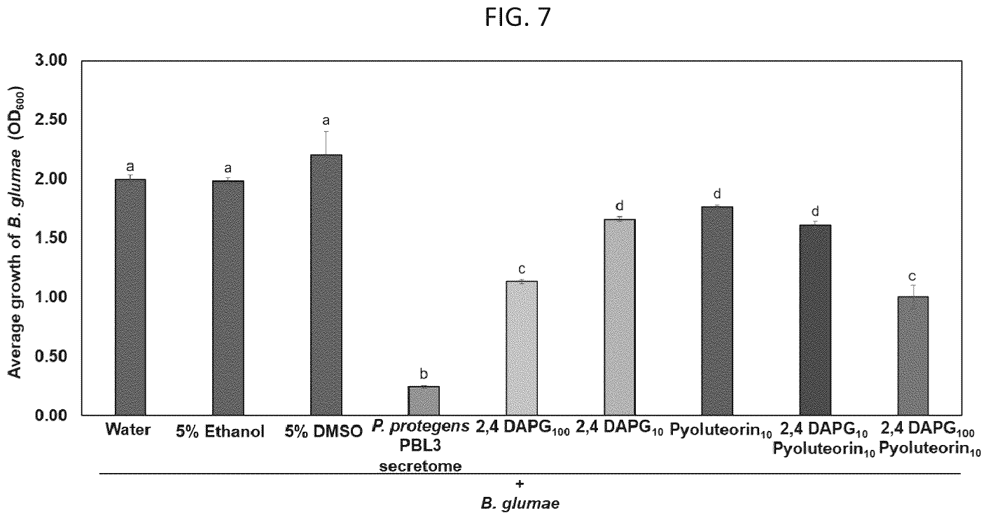

Genome sequencing of P. protegens PBL3 revealed the presence of gene clusters responsible for the biosynthesis of the secondary metabolites orfamide, fengycin, pyrrolnitrin, pyochelin, pyoverdine, 2,4-DAPG, and pyoluteorin (Ortega et al. 2020). To evaluate whether these secondary metabolites contribute to the antimicrobial activity against B. glumae, we obtained the commercially available compounds orfamide A, orfamide B, fengycin, pyrrolnitrin, pyochelin, pyoverdine, 2,4-DAPG, and pyoluteorin, and used them at different concentrations to amend the KB broth used for B. glumae growth. The results showed that B. glume in KB or KB containing 5% DMSO or 5% ethanol (solvents for compounds), grew to an average OD₆₀₀ of 2.15, whereas the growth of B. glumae in KB amended with the P. protegens PBL3 secretome showed a 90% reduction, reaching an OD₆₀₀ of 0.24. Orfamide A, orfamide B, and fengycin added to KB and at concentrations ranging from 10 μg/mL to 1000 μg/mL did not reduce the growth of B. glumae (FIG. 2). Pyrrolnitrin and pyochelin added to KB at 1000 μg/mL, significantly reduced the growth of B. glumae by 25% and 40%, respectively, but did not have any effect at other concentrations. For pyoverdine, 1000 μg/mL and 100 μg/mL were the most effective concentrations, reducing the growth of B. glumae by ˜ 80%, whereas 2,4-DAPG and pyoluteorin significantly reduced the growth of B. glumae at the three concentrations used, in a concentration-dependent manner. For, 2,4-DAPG, the most effective concentration was 1000 μg/mL, reducing the growth of B. glumae by 93%, and for pyoluteorin the most effective concentrations were 1000 μg/mL and 100 μg/mL, reducing the growth of B. glumae by 97%. Interestingly, the highest effective concentrations of 2,4-DAPG and pyoluteorin dramatically reduced B. glumae growth to levels lower than those observed when using the whole P. protegens PBL3 secretome (FIG. 2). The minimum inhibitory concentration needed for reduction of B. glumae growth in vitro for pyrrolnitrin and pyochelin was 1000 μg/mL, while for pyoverdine, 2,4-DAPG, and pyoluteorin it was 100 μg/mL. Altogether, these results highlight pyoverdine, 2,4-DAPG, and pyoluteorin as strong candidate molecules responsible for the antimicrobial activity of P. protegens PBL3 against B. glumae. The significant reduction in the growth of B. glumae with the addition of 2,4-DAPG at 1000 μg/mL and pyoluteorin at both 1000 μg/mL and 100 μg/mL prompted us to evaluate whether combining these compounds would still recapitulate the effect of the entire P. protegens PBL3 secretome when added at lower concentrations. For that purpose, we tested two different combinations of 2,4-DAPG and pyoluteorin. When combining 2,4-DAPG and pyoluteorin at a final concentration of 10 μg/mL each (2,4-DAPG₁₀/Pyoluteorin₁₀), there was not a significant impact on the reduction of B. glumae growth when compared with the effect of each compound alone at the same final concentration. However, when the concentration of 2,4-DAPG was increased to 100 μg/mL while keeping the concentration of pyoluteorin at 10 μg/mL (2,4-DAPG₁₀₀/Pyoluteorin₁₀), we observed a 51% reduction in B. glumae growth comparable to the reduction in growth when 2,4-DAPG at 100 μg/mL (45% reduction) (FIG. 7). These results suggest that 2,4-DAPG and pyoluteorin do not have additive effect at the concentrations tested and that the antimicrobial effect of 2,4-DAPG masks the effect of pyoluteorin.

Secondary Metabolites Detected in the P. protegens PBL3 Secretome are in Low Abundance

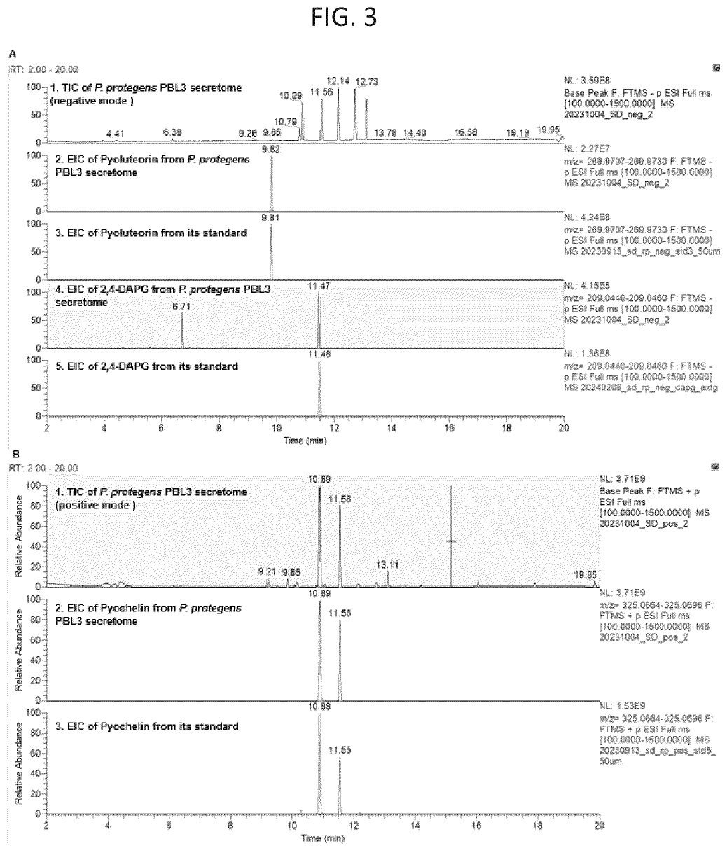

To further evaluate if the P. protegens PBL3 secretome contains any of the secondary metabolites predicted by the P. protegens PBL3 genomic sequence, we analyzed the P. protegens PBL3 secretome using an untargeted approach, i.e., reverse phase liquid chromatography-tandem mass spectrometry (RPLC-MS/MS). To confirm the detection and identification of the compounds, standards of commercially available orfamide, fengycin, pyrrolnitrin, pyochelin, pyoverdine, 2,4-DAPG, and pyoluteorin were run alongside the samples of P. protegens PBL3 secretome. Orfamide, fengycin, pyrrolnitrin, and pyoverdine were not detected in the P. protegens PBL3 secretome (data not shown). Pyoluteorin and 2,4-DAPG were detected in the P. protegens PBL3 secretome in negative ion mode at 9.8 minutes and 11.4 minutes, respectively (FIG. 3A). The average concentrations calculated based on the extracted ion chromatograms and the external standard curves were found to be 72.1 ng/ml for pyoluteorin and 7.6 ng/ml for 2,4-DAPG, although there was significant variation among biological replicates (Table 1). We also detected pyochelin in positive ion mode as two peaks at retention times of 10.8 minutes and 11.5 minutes, corresponding to two stereoisomers, pyochelin I and pyochelin II (FIG. 3B). The average concentrations were calculated to be 15.9 μg/mL and 25.4 μg/mL for pyochelin I and pyochelin II, respectively (Table 1). It is important to note that although pyochelin seems to be very abundant in the sample relatively to other compounds detected (FIG. 3), the concentrations of pyochelin and the others, pyoluteorin and 2,4-DAPG, detected in the P. protegens PBL3 secretome are significantly lower than the minimum inhibitory concentrations determined in vitro to reduce the growth of B. glumae as observed in FIG. 2.

TABLE 1
Quantification of pyochelin, pyoluteorin, and 2,4-DAPG

| Sample summary | Concentration (μg/mL) | | | | |
|---|---|---|---|---|---|
| Sample name/ | | | Total | Concentration (ng/mL) | |
| Biological replicate | Pyochelin1 | Pyochelin2 | Pyochelin | Pyoluteorin | 2,4-DAPG |
| P. protegens PBL3 | 16.6 | 26 | 42.6 | 33.5 | 3.2 |
| secretome-1 | | | | | |
| P. protegens PBL3 | 13.9 | 22.6 | 36.5 | 97.5 | 6.7 |
| secretome-2 | | | | | |
| P. protegens PBL3 | 15.1 | 24.6 | 39.7 | 41.3 | 5 |
| secretome-3 | | | | | |
| P. protegens PBL3 | 18 | 28.3 | 46.3 | 116.4 | 15.5 |
| secretome-4 | | | | | |
| Average | 15.9 | 25.4 | 41.3 | 72.1 | 7.6 |
| concentration | | | | | |

*Pyochelin has two epimers

### Purified Pyoluteorin, 2,4-DAPG, and Pyochelin can Reduce the BPB Symptoms in Rice Panicles

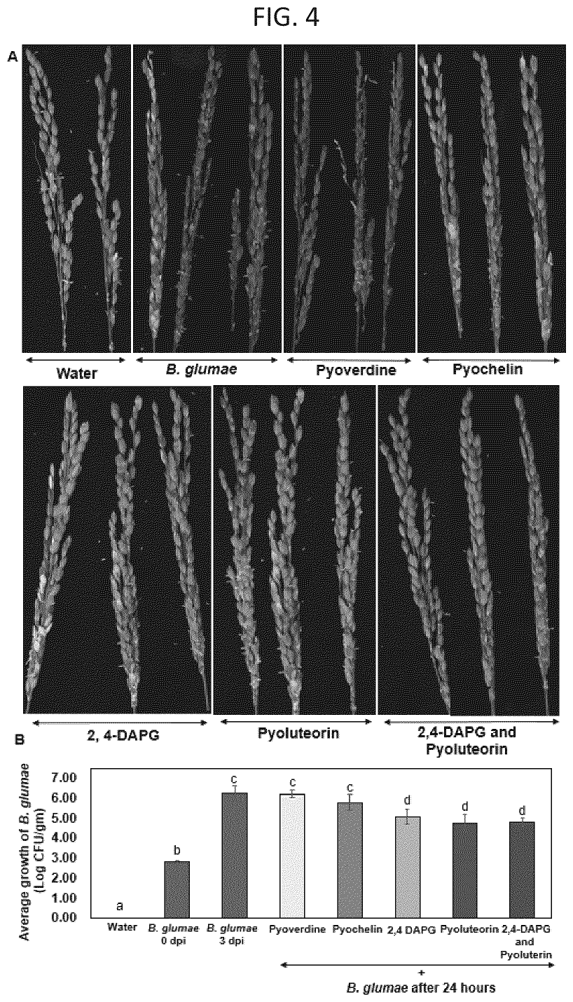

The findings that pyochelin, pyoverdine, 2,4-DAPG, and pyoluteorin showed significant in vitro reduction in the growth of B. glumae, prompted us to evaluate the effectiveness of those compounds in planta by evaluating their effect on BPB symptoms and B. glumae growth. For that purpose, we pre-treated rice panicles with water, pyoverdine, pyochelin, 2,4-DAPG, and pyoluteorin prior to inoculation with B. glumae. We chose a final concentration of 500 μg/mL, which was empirically determined. The results showed that rice panicles pre-treated with water followed with inoculation with B. glumae exhibited the highest levels of BPB symptoms, characterized by discoloration of the spikelets. Similar results were obtained when panicles were pre-treated with pyoverdine. In contrast, rice panicles pre-treated with pyochelin, 2,4-DAPG, and pyoluteorin showed reduction of symptoms (FIG. 4A). Since 2,4-DAPG and pyoluteorin were the most effective in vitro, we also evaluated their combined effect in panicles and found that rice panicles pre-treated with combination of pyoluteorin and 2,4-DAPG showed same level of reduction in the symptoms as pre-treated with each compound alone (FIG. 4A). Furthermore, to provide meaningful quantification of the differences between all the treatments, we evaluated B. glumae populations after 3 dpi. After 3 dpi of B. glumae, rice panicles pre-treated with water and inoculated with B. glumae showed B. glumae populations that were 3.5 logs higher when compared with the initial populations at 0 dpi. No changes in B. glumae populations were observed when rice panicles were pre-treated with pyoverdine or pyochelin. Rice panicles pre-treated with 2,4-DAPG and pyoluteorin showed reduction of B. glumae populations of 1.17 and 1.5 logs, respectively. Additionally, rice panicles pre-treated with combination of pyoluteorin and 2,4-DAPG showed B. glumae populations that were 1.5 logs lower than negative control and that reduction was equivalent to reduction in bacterial population when pre-treated with pyoluteorin or 2,4-DAPG alone (FIG. 4B). These findings indicate that pyoluteorin and 2,4-DAPG have an important effect reducing disease and bacterial populations associated with BPB.

Pseudomonas protegens PBL3 Secretome Improved Seed Germination of B. glumae-Infected Rice Seed

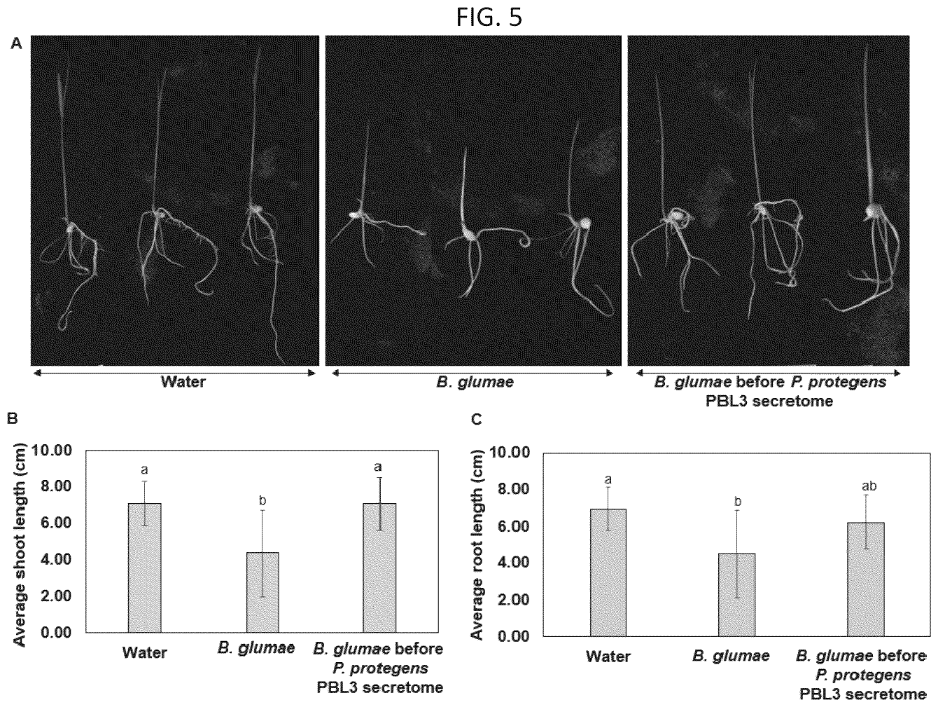

To assess the efficacy of P. protegens PLB3 secretome as a seed treatment, B. glumae-inoculated seeds were treated with the P. protegens PBL3 secretome. As expected, B. glumae infection interfered with seed germination (4 out of 20 inoculated seeds) (data not shown), or hindered seed germination causing reduction in root and shoot length (FIG. 5A). In contrast, seeds infected with B. glumae and subsequently treated with the P. protegens PLB3 secretome germinated and their root and shoot lengths were equivalent to water-treated controls (FIG. 5A). Quantitative analysis of seedling growth revealed that the P. protegens PLB3 secretome remarkably enhanced shoot growth in rice. The shoot length of seedlings treated with the secretome after B. glumae infection was significantly greater compared to those treated only with B. glumae, with an increase of 2.7 cm (FIG. 5B). While B. glumae infection reduced root length by 2.5 cm compared to water-treated seeds, treatment with the P. protegens PLB3 secretome increased root length by 1.75 cm, showing an intermediate effect between water-treated and B. glumae-infected seeds (FIG. 5C).

### Discussion

The genus Pseudomonas is prolific in the production of secondary metabolites with antagonistic properties against a wide range of plant pathogens, and therefore represent promising biocontrol agents, some of which have already been commercialized (Castro Tapia et al. 2020; Chin-A-Woeng et al. 2003; Dimkic et al. 2022; Hofte 2021; Mercado-Blanco 2021; Müller and Behrendt 2021).

The most recognized secondary metabolites produced by Pseudomonas spp. include phenazines, phloroglucinols, dialkyresorcinols, pyocyanin, pyrrolnitrin, pyoluteorin, 2,4-diacetylphloroglucinol (DAPG), siderophores (pyoverdines, pyochelin, pseudobactins, and quinolones), rhizoxins, hydrogen cyanide, and cyclic-lipopeptides (CLPs) (Dimkic et al. 2022; Gross and Loper 2009; Mark et al. 2006; Mishra and Arora 2018). Some of those secondary metabolites have already been identified in other strains of P. protegens as powerful antimicrobials against some fungal and bacterial pathogens affecting different plants (Balthazar et al. 2022; Castro Tapia et al. 2020; Gu et al. 2022; Howell and Stipanovic 1980; Maurhofer et al. 1994; Michavila et al. 2017; Rai et al. 2017).

Similar to other P. protegens strains, the genome sequence of P. protegens PBL3 also predicted the coding capacity for secondary metabolites, but their abundance or specific antimicrobial activity was unknown. Our efforts to identify effective antimicrobials to combat B. glumae, led us to validate the abundance and antimicrobial activity of putative secondary metabolites predicted by the P. protegens PBL3 genomic sequence. By combining in vitro antimicrobial assays using purified secondary metabolites commercially available with mass spectrometry, we narrowed down which specific secondary metabolites in the P. protegens PBL3 secretome contributed to the antimicrobial activity against B. glumae. Specifically, our results showed that some of the genome predicted secondary metabolites such as orfamide A, orfamide B, and fengycin do not have antimicrobial activity against B. glumae, and our methods did not detect them in the P. protegens PBL3 secretome. Pyrrolnitrin exhibited moderate levels of activity at the highest concentration used, whereas pyoverdine demonstrated varying degree of activity in a concentration-dependent manner. Since none of those five secondary metabolites were detected in the P. protegens PBL3 secretome, they are unlikely the ones responsible for the P. protegens PBL3 activity, although purified pyoverdine at 1000 μg/mL and 100 μg/mL showed equivalent levels of growth inhibition to the levels of growth inhibition obtained with the complete P. protegens PBL3 secretome.

The detection of pyochelin in the P. protegens PBL3 secretome and its high concentration was intriguing and prompted us to include it in our in planta assays. In agreement with the reduced activity in vitro, pre-treatment of rice panicles with pyochelin did not protect them against inoculation with B. glumae.

Although the concentrations of pyoluteorin and 2,4-DAPG in the P. protegens PBL3 secretome were below the concentrations required for activity in vitro, their significant levels of activity in vitro led us to evaluate their activity in rice panicles. The results showed that both pyoluteorin and 2,4-DAPG reduced BPB disease symptoms as well as B. glumae growth.

Our findings that pyoluteorin and 2,4-DAPG are the most effective metabolites to reduce B. glumae growth in vitro and in planta are in agreement with previous results in other pathosystems. Pyoluteorin has been found to be effective against Heterobasidion spp., Botrytis cinerea, Pythium ultimum, Pantoea ananatis, and Ralstonia solanacearum (Balthazar et al. 2022; Clough et al. 2022; Gu et al. 2022; Howell and Stipanovic 1980; Maurhofer et al. 1994; Pellicciaro et al. 2022), whereas 2,4-DAPG has been found effective against Botrytis cinerea, Erwinia carotovora subsp. atroseptica, R. solanacearum, and Xanthomonas oryzae pv. oryzae (Balthazar et al. 2022; Clough et al. 2022; Cronin et al. 1997; Rai et al. 2017; Velusamy et al. 2006), and pyochelin enantiomers have been found effective against Xanthomonas citri subsp. citri and X. oryzae pv. oryzae (Michavila et al. 2017; Yasmin et al. 2017).

Our results demonstrating the effectiveness of the P. protegens PBL3 secretome for controlling BPB in seedling assays are promising and encourage the development of the P. protegens PBL3 secretome as a sustainable resource to mitigate BPB. Still, more work is needed to demonstrate its effectiveness in large scale greenhouse and field assays and to fully understand its chemical complexity.

### REFERENCES

Atuesta, G. C. P., Arango, W. M., Eras, J., Oliveros, D. F. and Arteaga, J. J. M. (2020) Rice-Associated Rhizobacteria as a Source of Secondary Metabolites against Burkholderia glumae. Molecules, 25.
Balthazar, C., St-Onge, R., Leger, G., Lamarre, S. G., Joly, D. L. and Filion, M. (2022) Pyoluteorin and 2,4-diacetylphloroglucinol are major contributors to Pseudomonas protegens Pf-5 biocontrol against Botrytis cinerea in cannabis. Front Microbiol, 13, 945498.
Bertani, G. (1951) Studies on lysogenesis. I. The mode of phage liberation by lysogenic Escherichia coli. J Bacteriol, 62, 293-300.
Betancur, L. A., Forero, A. M., Vinchira-Villarraga, D. M., Cardenas, J. D., Romero-Otero, A., Chagas, F. O., Pupo, M. T., Castellanos, L., and Ramos, F. A. 2020. NMR-based metabolic profiling to follow the production of anti-phytopathogenic compounds in the culture of the marine strain Streptomyces sp. PNM-9. Microbiol Res. 239, 126507.
Castro Tapia, M. P., Madariaga Burrows, R. P., Ruiz Sepulveda, B., Vargas Concha, M., Vera Palma, C. and Moya-Elizondo, E. A. (2020) Antagonistic Activity of Chilean Strains of Pseudomonas protegens Against Fungi Causing Crown and Root Rot of Wheat (Triticum aestivum L.). Front Plant Sci, 11, 951.
Childs, N. and LeBeau, B. (2023) U.S. 2023/24 Rice Production Projected to Increase 20 Percent to 192.7 Million Hundredweight. (Service, E. R., ed.). United States Department of Agriculture.
Chin-A-Woeng, T. F. C., Bloemberg, G. V. and Lugtenberg, B. J. J. (2003) Phenazines and their role in biocontrol by bacteria. New Phytologist, 157, 503-523.
Chung, E. J., Hossain, M. T., Khan, A., Kim, K. H., Jeon, C. O. and Chung, Y. R. (2015) Bacillus oryzicola sp. nov., an Endophytic Bacterium Isolated from the Roots of Rice with Antimicrobial, Plant Growth Promoting, and Systemic Resistance Inducing Activities in Rice. The plant pathology journal, 31, 152-164.
Clough, S. E., Jousset, A., Elphinstone, J. G. and Friman, V. P. (2022) Combining in vitro and in vivo screening to identify efficient Pseudomonas biocontrol strains against the phytopathogenic bacterium Ralstonia solanacearum. Microbiologyopen, 11, e1283.
Cronin, D., MoenneLoccoz, T., Fenton, A., Dunne, C., Dowling, D. N., and OGara, F. 1997.
Ecological interaction of a biocontrol Pseudomonas fluorescens strain producing 2,4-diacetylphloroglucinol with the soft rot potato pathogen Erwinia carotovora subsp. atroseptica. Fems Microbiology Ecology. 23, 95-106.
Dimkic, I., Janakiev, T., Petrovic, M., Degrassi, G. and Fira, D. (2022) Plant-associated Bacillus and Pseudomonas antimicrobial activities in plant disease suppression via biological control mechanisms-A review. Physiol Mol Plant P, 117.
Echeverri-Rico, J., Petro, E., Fory, P. A., Mosquera, G. M., Lang, J. M., Leach, J. E., et al. (2021) Understanding the complexity of disease-climate interactions for rice bacterial panicle blight under tropical conditions. PLOS One, 16, e0252061.
Fory, P. A., Triplett, L., Ballen, C., Abello, J. F., Duitama, J., Aricapa, M. G., et al. (2014) Comparative analysis of two emerging rice seed bacterial pathogens. Phytopathology, 104, 436-444.
Gross, H. and Loper, J. E. (2009) Genomics of secondary metabolite production by spp. Nat Prod Rep, 26, 1408-1446.
Gu, Q., Qiao, J., Wang, R., Lu, J., Wang, Z., Li, P., et al. (2022) The Role of Pyoluteorin from Pseudomonas protegens Pf-5 in Suppressing the Growth and Pathogenicity of Pantoea ananatis on Maize. Int J Mol Sci, 23.
Ham, J. H., Melanson, R. A. and Rush, M. C. (2011) Burkholderia glumae: next major pathogen of rice? Mol Plant Pathol, 12, 329-339.
Hikichi, Y. (1993) Antibacterial activity of oxolinic acid on Pseudomonas glumae. Japanese Journal Phytopath, 59, 369-374.
Hofte, M. (2021) The use of Pseudomonas spp. as bacteria biocontrol agenst to control plant disease. In: Microbial bioprotectants for plant disease management. (Kohl, J. and Ravensberg, W. J., eds.).
Howell, C. R. and Stipanovic, R. D. (1980) Suppression of Pythium-Ultimum-Induced Damping-Off of Cotton Seedlings by Pseudomonas-Fluorescens and Its Antibiotic, Pyoluteorin. Phytopathology, 70, 712-715.
King, E. O., Ward, M. K. and Raney, D. E. (1954) Two simple media for the demonstration of pyocyanin and fluorescin. J Lab Clin Med, 44, 301-307.
Kouzai, Y. and Akimoto-Tomiyama, C. (2022) A Seed-Borne Bacterium of Rice, Pantoea dispersa BB1, Protects Rice from the Seedling Rot Caused by the Bacterial Pathogen Burkholderia glumae. Life-Basel, 12.
Lee, Y. H., Ko, S. J., Cha, K. H. and Park, E. W. (2015) BGRcast: A Disease Forecast Model to Support Decision-making for Chemical Sprays to Control Bacterial Grain Rot of Rice. The plant pathology journal, 31, 350-362.
Maeda, Y., Kiba, A., Ohnishi, K. and Hikichi, Y. (2004) Implications of amino acid substitutions in GyrA at position 83 in terms of oxolinic acid resistance in field isolates of Burkholderia glumae, a causal agent of bacterial seedling rot and grain rot of rice. Applied and environmental microbiology, 70, 5613-5620.
Mark, G., Morrissey, J. P., Higgins, P. and O'Gara, F. (2006) Molecular-based strategies to exploit Pseudomonas biocontrol strains for environmental biotechnology applications. FEMS Microbiol Ecol, 56, 167-177.
Maurhofer, M., Keel, C., Haas, D. and Defago, G. (1994a) Pyoluteorin production by Pseudomonas fluorescens strain CHAO is involved in the suppression of Pythium damping-off of cress but not of cucumber. Eur J. Plant Pathol, 100, 221-232.
Mercado-Blanco, J. (2021) Pseudomonas strains that exert biocontrol of plant pathogens. In: Pseudomonas. (Ramos, J. L., Goldberg, J. B. and Filloux, A., eds.).
Michavila, G., Adler, C., De Gregorio, P. R., Lami, M. J., Caram Di Santo, M. C., Zenoff, A. M., et al. (2017a) Pseudomonas protegens CSI from the lemon phyllosphere as a candidate for citrus canker biocontrol agent. Plant Biol (Stuttg), 19, 608-617.
Mishra, J. and Arora, N. K. (2018) Secondary metabolites of fluorescent pseudomonads in biocontrol of phytopathogens for sustainable agriculture. Appl Soil Ecol, 125, 35-45.
Müller, T. and Behrendt, U. (2021) Exploiting the biocontrol potential of plant-associated pseudomonads—A step towards pesticide-free agriculture? Biological Control, 155.
Ngalimat, M. S., Hata, E. M., Zulperi, D., Ismail, S. I., Ismail, M. R., Zainudin, N., et al. (2022) Streptomyces-mediated growth enhancement and Bacterial Panicle Blight disease suppression in rice plants under greenhouse conditions. J Biotechnol, 359, 148-160.
Ortega, L. and Rojas, C. M. (2021) Bacterial Panicle Blight and Burkholderia glumae: From Pathogen Biology to Disease Control. Phytopathology, 111, 772-778.
Ortega, L., Walker, K. A., Patrick, C., Wamishe, Y., Rojas, A. and Rojas, C. M. (2020) Harnessing Pseudomonas protegens to Control Bacterial Panicle Blight of Rice. Phytopathology, 110, 1657-1667.
Pedraza-Herrera, L. A., Bautista, J. P., Cruz-Ramirez, C. A. and Uribe-Velez, D. (2021) IBUN2755 strain controls seedling root and bacterial panicle blight caused by Burkholderia glumae. Biological Control, 153.
Pellicciaro, M., Padoan, E., Lione, G., Celi, L. and Gonthier, P. (2022) Pyoluteorin Produced by the Biocontrol Agent Pseudomonas protegens Is Involved in the Inhibition of Heterobasidion Species Present in Europe. Pathogens, 11.
Rai, R., Srinivasamurthy, R., Dash, P. K. and Gupta, P. (2017a) Isolation, characterization and evaluation of the biocontrol potential of RS-9 against in Tomato. Indian J Exp Biol, 55, 595-603.
Shew, A. M., Durand-Morat, A., Nalley, L. L., Zhou, X. G., Rojas, C. and Thoma, G. (2019) Warming increases Bacterial Panicle Blight (Burkholderia glumae) occurrences and impacts on USA rice production. PLOS One, 14, e0219199.
Shrestha, B. K., Karki, H. S., Groth, D. E., Jungkhun, N. and Ham, J. H. (2016) Biological Control Activities of Rice-Associated Bacillus sp. Strains against Sheath Blight and Bacterial Panicle Blight of Rice. PLOS One, 11, e0146764.
Suarez-Moreno, Z. R., Vinchira-Villarraga, D. M., Vergara-Morales, D. I., Castellanos, L., Ramos, F. A., Guarnaccia, C., et al. (2019) Plant-Growth Promotion and Biocontrol Properties of Three Streptomyces spp. Isolates to Control Bacterial Rice Pathogens. Frontiers in microbiology, 10, 290.
Velusamy, P., Immanuel, J. E., Gnanamanickam, S. S. and Thomashow, L. (2006) Biological control of rice bacterial blight by plant-associated bacteria producing 2,4-diacetylphloroglucinol. Can J Microbiol, 52, 56-65.
Yasmin, S., Hafeez, F. Y., Mirza, M. S., Rasul, M., Arshad, H. M. I., Zubair, M., et al. (2017) Biocontrol of Bacterial Leaf Blight of Rice and Profiling of Secondary Metabolites Produced by Rhizospheric Pseudomonas aeruginosa BRp3. Frontiers in Microbiology, 8.
Zhou, X. G. (2019) Sustainable Strategies for Managing Bacterial Panicle Blight of Rice. In: Protecting Rice Grains in the Post-Genomics Era. IntechOpen.

### DEPOSIT INFORMATION

A deposit of the Board of Trustees of the University of Arkansas proprietary Pseudomonas protegens strain designated as PBL3 disclosed above and recited in the appended claims has been made with the ARS Culture Collection (NRRL), 1815 N. University Street, Peoria, IL 61604, and has been accepted under the terms of the Budapest Treaty. The date of deposit was Nov. 17, 2021. The deposit comprises 5 liquid nitrogen stocks of the strain, which were found viable on Nov. 18, 2021. All restrictions will be irrevocably removed upon granting of a patent, and the deposit is intended to meet all the requirements of 37 C.F.R. §§ 1.801-1.809. The NRRL Accession Number is B-68083. The deposit will be maintained in the depository for a period of thirty years, or five years after the last request, or for the enforceable life of the patent, whichever is longer, and will be replaced as necessary during that period.

What is claimed:

1. An antimicrobial composition comprising pyrrolnitrin, pyochelin, pyoverdine, 2,4-diacetylphloroglucinol (2,4-DAPG), pyoluteorin, or a combination thereof.

2. The antimicrobial composition of claim 1, wherein the composition comprises two or more of pyrrolnitrin, pyochelin, pyoverdine, 2,4-DAPG, and pyoluteorin.

3. The antimicrobial composition of claim 1, wherein the composition comprises pyochelin, 2,4-DAPG, and/or pyoluteorin.

4. The antimicrobial composition of claim 3, wherein the composition comprises 2,4-DAPG and/or pyoluteorin.

5. The antimicrobial composition of claim 1, wherein the composition comprises:
a) pyrrolnitrin at a concentration of 100-5000 μg/mL;
b) pyochelin at a concentration of 50-5000 μg/mL;
c) pyoverdine at a concentration of 5-5000 μg/mL;
d) 2,4-DAPG at a concentration of 5-5000 μg/mL;
e) pyoluteorin at a concentration of 5-5000 μg/mL; or
f) any combination thereof.

6. The antimicrobial composition of claim 5, wherein the composition comprises:
a) pyrrolnitrin at a concentration of 1000 μg/mL;
b) pyochelin at a concentration of 100 μg/mL or 1000 μg/mL;
c) pyoverdine at a concentration of 10 μg/mL, 100 μg/mL, or 1000 μg/mL;
d) 2,4-DAPG at a concentration of 10 μg/mL, 100 μg/mL, or 1000 μg/mL;
e) pyoluteorin at a concentration of 10 μg/mL, 100 μg/mL, or 1000 μg/mL; or
f) any combination thereof.

7. The antimicrobial composition of claim 1, wherein the composition is an agricultural composition.

8. A method of inhibiting the growth of a microorganism, the method comprising contacting the microorganism with the antimicrobial composition of claim 1, thereby inhibiting its growth.

9. The method of claim 8, wherein the growth of the microorganism is inhibited on a plant.

10. The method of claim 9, wherein the plant is a rice plant.

11. The method of claim 9, wherein the contacting is carried out by spraying or dusting the plant or a portion of the plant with the antimicrobial composition.

12. The method of claim 9, wherein the contacting is carried out before flowering or during panicle formation.

13. The method of claim 8, wherein the microorganism is a bacterium or a fungus.

14. The method of claim 13, wherein the microorganism is Burkholderia glumae.

15. The method of claim 14, wherein the plant is a rice plant and the method reduces symptoms of bacterial panicle blight.

16. The method of claim 8, wherein the composition comprises two or more of pyrrolnitrin, pyochelin, pyoverdine, 2,4-DAPG, and pyoluteorin.

17. The method of claim 8, wherein the composition comprises pyochelin, 2,4-DAPG, and/or pyoluteorin.

18. The method of claim 17, wherein the composition comprises 2,4-DAPG and/or pyoluteorin.

19. The method of claim 8, wherein the composition comprises:
a) pyrrolnitrin at a concentration of 100-5000 μg/mL;
b) pyochelin at a concentration of 50-5000 μg/mL;
c) pyoverdine at a concentration of 5-5000 μg/mL;
d) 2,4-DAPG at a concentration of 5-5000 μg/mL;
e) pyoluteorin at a concentration of 5-5000 μg/mL; or
f) any combination thereof.

20. The method of claim 19, wherein the composition comprises:
a) pyrrolnitrin at a concentration of 1000 μg/mL;
b) pyochelin at a concentration of 100 μg/mL or 1000 μg/mL;
c) pyoverdine at a concentration of 10 μg/mL, 100 μg/mL, or 1000 μg/mL;
d) 2,4-DAPG at a concentration of 10 μg/mL, 100 μg/mL, or 1000 μg/mL;
e) pyoluteorin at a concentration of 10 μg/mL, 100 μg/mL, or 1000 μg/mL; or
f) any combination thereof.
